(19) United States
(12) Patent Application Publication
(10) Pub. No.: US 2013/0112928 A1
(43) Pub. Date: May 9, 2013

(54) AQUEOUS ELECTRODE BINDER FOR SECONDARY BATTERY

(71) Applicants: Kazushi Omote, Suita-shi (JP); Kazuhisa Hirata, Suita-shi (JP)

(72) Inventors: Kazushi Omote, Suita-shi (JP); Kazuhisa Hirata, Suita-shi (JP)

(73) Assignee: NIPPON SHOKUBAI CO, LTD., Osaka-shi, Osaka (JP)

(21) Appl. No.: 13/810,289

(22) PCT Filed: Jul. 14, 2011
(86) PCT No.: PCT/JP2011/066136

§ 371 Date: Jan. 15, 2013

(30) Foreign Application Priority Data
Jul. 16, 2010 (JP) 2010-161425
Jul. 30, 2010 (JP) 2010-171446
Oct. 26, 2010 (JP) 2010-239424
Oct. 27, 2010 (JP) 2010-240807

(51) Int. Cl. H01M 4/62

(52) U.S. Cl. CPC H01M 4/623
USPC 252/511; 524/556; 252/500; 252/519.34

(57) ABSTRACT

The present invention provides an aqueous electrode binder for a secondary battery suitable as a water-soluble binder that is included in a composition forming an electrode for secondary battery, and does not reduce adhesion and flexibility of an emulsion because a water-soluble polymer is included that has dispersibility and a viscosity control function, and that supplementary works when an electrode is formed. An aqueous electrode binder for a secondary battery includes a water-soluble polymer, wherein the water-soluble polymer includes a structural unit (a) derived from an ethylenically unsaturated carboxylic acid ester monomer in an amount of 50 to 95% by mass and a structural unit (b) derived from an ethylenically unsaturated carboxylic salt monomer in an amount of 5 to 50% by mass, based on 100% by mass of the total amount of the structural units included in the water-soluble polymer, and wherein the water-soluble polymer has a weight-average molecular weight of 500,000 or more.

### TECHNICAL FIELD

The present invention relates to an aqueous electrode binder for a secondary battery.

### BACKGROUND ART

Secondary batteries are repeatedly rechargeable batteries. In recent years, attention has been increasingly focused on environmental problems, and therefore, secondary batteries have been used not only in electric devices such as cell phones and laptop computers but also in other fields such as vehicles and aircrafts. Such high demand for secondary batteries has promoted research thereon. Among secondary batteries, light weight, small sized, and high-energy-density lithium ion batteries have attracted attention in industries, and have been actively developed.

Lithium ion batteries mainly include a positive electrode, an electrolyte, a negative electrode, and a separator. Among them, the electrodes are formed by applying an electrode composition on a collector.

With respect to an electrode composition, a positive-electrode composition is used for the formation of a positive electrode, and mainly includes a positive-electrode active material, a conductive additive, a binder, and a solvent. Polyvinylidene fluoride (PVDF) is usually used as the binder. N-methyl-2-pyrrolidone (NMP) is usually used as the solvent.

This is because PVDF is chemically and electrically stable, NMP is a solvent that dissolves PVDF and is less likely to be deteriorated with time, and an organic solvent needs to be used because lithium cobalt oxide generally used as a positive-electrode active material may be hydrolyzed in water.

However, low-molecular-weight PVDF has insufficient adhesion, and on the other hand, high-molecular-weight PVDF has low dissolution concentration and use of the high-molecular-weight PVDF is less likely to increase the solids concentration. Further, NMP has a high boiling point, and therefore, there is a problem that volatilization of NMP used as a solvent needs a large amount of energy when electrode is formed. In addition to this, in recent years, attention has been increasingly focused on environmental problems, and therefore, an aqueous electrode composition free from an organic solvent has been needed.

Under such circumstances, positive-electrode compositions and binders capable of being used for positive-electrode compositions have been studied and developed.

As a composition forming a positive electrode of a secondary battery, a positive electrode that is formed by a positive-electrode aqueous paste containing a positive-electrode active material, a water-dispersing elastomer and a water-soluble polymer as a thickner is disclosed. Among them, water-soluble polymers are, for example, celluloses or polycarboxylic acid compounds (refer to Patent Literatures 1 and 2). Further, polymer particles having a structural unit derived from an ethylenically unsaturated carboxylic acid ester monomer and a structural unit derived from an ethylenically unsaturated carboxylic acid monomer are disclosed as a binder composition for a battery (refer to Patent Literature 3).

In contrast, with respect to an electrode composition, a negative-electrode composition used for the formation of a negative electrode mainly includes a negative-electrode active material, a binder, and a solvent. With respect to the binder, polyvinylidene fluoride (PVDF) is commonly used in a solvent system (N-methyl-2-pyrrolidone (NMP) is used as a solvent), and carboxymethylcellulose (CMC) and styrene butadiene rubber (SBR) are commonly used in combination in an aqueous system.

For the above-described concern about environmental problems, with respect to a negative-electrode aqueous composition, an aqueous system has been examined instead of a solvent one. Commonly, in an aqueous system, as an aqueous binder, a water-soluble polymer that provides dispersibility and a viscosity control function, which is represented by CMC, and an emulsion (an aqueous dispersion of polymer particles) as a binding agent that improves flexibility of an electrode or binds active material particles to one another, which is represented by SBR, are generally used in combination.

As a water-soluble polymer as a binder for a negative electrode of a secondary battery, celluloses, polycarboxylic acid compounds, and the like are mainly examined and exemplified.

In cases where a polycarboxylic acid compound is used as a water-soluble polymer, a lithium salt of poly(meth)acrylic acid is disclosed (refer to Patent Literature 4). As a thickener for a negative electrode of a lithium-ion secondary battery (viscosity control agent), a copolymer obtainable by copolymerization of a (meth)acrylic acid polyoxyalkylene ether compound with an ethylenically unsaturated carboxylic acid is disclosed. A 2% by weight aqueous solution of the copolymer with pH 7 has viscosity of 1,000 to 20,000 mPa·s at a temperature of 25° C. (refer to Patent Literature 5).

### CITATION LIST

### Patent Literature

Patent Literature 1: JP 2005-63825 A
Patent Literature 2: JP 2006-134777 A
Patent Literature 3: JP 4389282 B
Patent Literature 4: JP 2001-283859 A
Patent Literature 5: JP 4412443 B

### SUMMARY OF INVENTION

### Technical Problem

As mentioned above, both a positive-electrode aqueous binder and a negative-electrode aqueous binder as aqueous electrode binders commonly include two components, that is, a water-soluble polymer and emulsion. The water-soluble polymer is mainly used as a dispersibility improving agent or a viscosity control agent. The emulsion is important in providing binding properties between particles and flexibility of an electrode. Various examinations have been made in order to achieve that the two components used in combination serve function as a binder.

With respect to a positive-electrode aqueous binder, Patent Literatures 1 and 2 disclose celluloses such as carboxymethylcellulose (CMC), polyacrylic acid compounds, compounds having a vinylpyrrolidone structure, and the like as a water-soluble polymer. Cellulose compounds are actually used. However, the formation and flexibility of an electrode are not necessarily sufficient. Therefore, there is room for improvement in them.

Further, Patent Literature 3 discloses polymer particles having a structural unit derived from an ethylenically unsaturated carboxylic acid ester monomer and a structural unit derived from an ethylenically unsaturated carboxylic acid monomer. Such polymer particles are used as an emulsion capable of giving binding properties and flexibility. In examples, a high flexible (low Tg) emulsion containing a large amount of 2-ethylhexyl acrylate is actually obtained, and is used as an emulsion capable of point binding among particles and giving flexibility. In Example 5, a positive-electrode composition is prepared using a lithium cobalt oxide as a positive-electrode active material in combination with CMC. The dispersion of particles and a viscosity control function are achieved by CMC. The emulsion containing a lot of 2-ethylhexyl acrylate is highly flexible, but highly hydrophobic. Therefore, compositions shown in examples are poorly soluble in water. Accordingly, the dispersion of particles and viscosity control have room for improvement.

On the other hand, with respect to a negative-electrode aqueous binder, in a system of CMC and an SBR emulsion, which are generally used as an aqueous negative-electrode composition, adhesion may be further required to be improved between a collector and the negative-electrode composition, or adverse effects on battery characteristics produced by CMC may become a problem.

In examples of Patent Literature 3, a negative-electrode aqueous composition including CMC is formed, and it is considered that the dispersibility improving and viscosity control are achieved by CMC. The emulsion containing a lot of 2-ethylhexyl acrylate contributes to the binding properties among particles and the flexibility of an electrode. However, since such an emulsion is highly hydrophobic, compositions shown in examples are poorly soluble in water, and the dispersibility and viscosity control have room for improvement.

Furthermore, Patent Literature 4 discloses that CMC in an electrode composition decomposes during heat drying of the electrode composition and produce water, and the water is less likely to be removed from an electrode active material layer, and therefore lithium salts of high-molecular-weight poly(meth)acrylic acid as an aqueous polymer are examined. As described in examples, the 1% aqueous solution of a lithium salt of high-molecular-weight poly(meth)acrylic acid is very highly viscous of 80,000 cps (described in the description). Therefore, if such a solution is used as a negative-electrode aqueous composition, the solids concentration is hardly increased, which may cause such as volume shrinkage when electrode is formed. Therefore, there is a room for improvement.

In examples of Patent Literature 5, a system of the combination of SBR and a copolymer obtainable by copolymerization of a polyoxyalkylene ether acrylate compound (a repeating unit of an oxyalkylene group: 8) with an ethylenically unsaturated carboxylic acid is examined. Use of such a polyoxyalkylene ether acrylate compound (a repeating unit of an oxyalkylene group: 8) as a main component of a copolymer increases a hydrophilic property of a polymer, and an ethyleneoxide chain prevents water elimination. Further, use of a compound having an alkylene oxide containing three or more carbon atoms provides high hydrophobicity, which results in use of a lot of acid groups to develop thickening properties. Therefore, such a system has a room for improving flexibility.

The present invention is made in view of the above-described circumstances and aims to provide an aqueous electrode binder for a secondary battery suitable as a water soluble binder that is included in a composition forming an electrode for secondary battery, and does not reduce adhesion and flexibility of an emulsion because the binder includes a water-soluble polymer that has dispersibility and a viscosity control function, and supplementary works when an electrode is formed.

### Solution to Problem

The present inventors made various investigations on an aqueous electrode binder capable of improving the adhesion and flexibility of an aqueous electrode composition. As a result, the present inventors found that use of an aqueous electrode binder comprising a water-soluble polymer including a structural unit derived from an ethylenically unsaturated carboxylic acid ester monomer and a structural unit derived from an ethylenically unsaturated carboxylic salt monomer in specific ratio, as an essential component; and including a water-soluble polymer having a weight-average molecular weight of 500,000 or more improves electrode formation, adhesion to a substrate, and flexibility without reducing dispersibility and a viscosity control function of an aqueous electrode composition.

Such a water-soluble polymer having a high molecular weight does not reduce the strength of a composition or an electrode even if included therein. Further, such a water-soluble polymer having a structural unit derived from an ethylenically unsaturated carboxylic acid ester monomer improves flexibility more than polyacrylic acid when an electrode is formed. Further, such a polymer can be formed into relatively high-molecular-weight one by emulsion polymerization, and such a polymer can be simply produced at low costs by making the polymer soluble in water using an alkali metal salt. Thus, the present invention can be completed.

That is, the present invention is an aqueous electrode binder for a secondary battery, comprising a water-soluble polymer, wherein the water-soluble polymer includes a structural unit (a) derived from an ethylenically unsaturated carboxylic acid ester monomer in an amount of 50 to 95% by mass and a structural unit (b) derived from an ethylenically unsaturated carboxylic salt monomer in an amount of 5 to 50% by mass, based on 100% by mass of the total amount of the structural units included in the water-soluble polymer, and wherein the water-soluble polymer has a weight-average molecular weight of 500,000 or more.

The present invention will be described in detail below.

The combinations of two or more of the preferable embodiments of the present invention described below are also preferable embodiments of the present invention.

The aqueous electrode binder for a secondary battery of the present invention comprises a water-soluble polymer (hereinafter, also referred to as “water-soluble polymer of the present invention”) that includes a structural unit (a) derived from an ethylenically unsaturated carboxylic acid ester monomer in an amount of 50 to 95% by mass and a structural unit (b) derived from an ethylenically unsaturated carboxylic salt monomer in an amount of 5 to 50% by mass, based on 100% by mass of the total amount of the structural units included in the water-soluble polymer, and that has a weight-average molecular weight of 500,000 or more. The aqueous electrode binder of the present invention may include any component and any additional water-soluble polymer as long as the binder includes the above water-soluble polymer. However, the aqueous electrode binder of the present invention preferably includes 10 to 100% by mass of the water-soluble polymer of the present invention based on 100% by mass of the total amount of the aqueous electrode binder of the present invention.

Further, the aqueous electrode binder of the present invention may include one type of the water-soluble polymer or two or more types of the water-soluble polymers of the present invention.

The structural unit (a) derived from an ethylenically unsaturated carboxylic acid ester monomer (hereinafter, also simply referred to as “structural unit (a)”) included as an essential component in the water-soluble polymer of the present invention, shows a structure in which a carbon-carbon double bond of an ethylenically unsaturated carboxylic acid ester monomer changes a single bond.

Examples of the ethylenically unsaturated carboxylic acid ester monomer include acrylic acid esters, methacrylic acid esters, and crotonic acid esters, or the like. The ethylenically unsaturated carboxylic acid ester monomer is preferably a compound represented by the formula (1):

CH₂═CR—C(═O)—OR′ (1)

wherein R represents a hydrogen atom or a methyl group, and R′ represents an alkyl group containing 1 to 10 carbon atoms, a cycloalkyl group containing 3 to 10 carbon atoms, or a hydroxyalkyl group containing 1 to 10 carbon atoms.

Examples of R′ in the formula (1) include alkyl groups containing 1 to 10 carbon atoms such as a methyl group, an ethyl group, a propyl group, a butyl group, an octyl group, and a 2-ethylhexyl group; cycloalkyl groups containing 3 to 10 carbon atoms such as a cyclopentyl group and a cyclohexyl group; and hydroxyalkyl groups containing 1 to 10 carbon atoms such as a hydroxyethyl group, a hydroxypropyl group, and a hydroxybutyl group.

Among these, highly hydrophobic groups, that is, alkyl groups containing 1 to 10 carbon atoms and cycloalkyl groups containing 3 to 10 carbon atoms, are preferable in terms of the below-described stability during emulsion polymerization. Alkyl groups containing 1 to 8 carbon atoms and cycloalkyl groups containing 3 to 8 carbon atoms are more preferable, and alkyl groups containing 1 to 6 carbon atoms are still more preferable. R′ in the formula (1) is preferably an alkyl group because the glass transition temperature (Tg) of the resulting water-soluble polymer becomes low. R′ is particularly preferably an alkyl group containing 1 to 4 carbon atoms, and most preferably an alkyl group containing 1 to 2 carbon atoms. In cases where R′ is an alkyl group containing 1 to 4 carbon atoms, a copolymer with an ethylenically unsaturated carboxylic salt monomer easily dissolves in water. The ethylenically unsaturated carboxylic acid ester monomers may be used singly or two or more of these may be used in combination.

The structural unit (b) derived from an ethylenically unsaturated carboxylic salt monomer (hereinafter, also simply referred to as “structural unit (b)”) included as an essential component in the water-soluble polymer of the present invention, shows a structure in which a carbon-carbon double bond of the ethylenically unsaturated carboxylic salt monomer changes a single bond.

Examples of the ethylenically unsaturated carboxylic salt monomer include ethylenically unsaturated monocarboxylic salt monomers containing 3 to 10 carbon atoms such as alkali metal salts of (meth)acrylic acid, crotonic acid, and isocrotonic acid; and ethylenically unsaturated dicarboxylic salt monomers containing 4 to 10 carbon atoms such as alkali metal salts of itaconic acid, maleic acid, fumaric acid, citraconic acid, mesaconic acid, and glutaconic acid. Among these, salts of unsaturated monocarboxylic acids containing 3 to 6 carbon atoms such as acrylic acid and methacrylic acid are preferable.

Examples of an alkali metal forming the alkali metal salt include lithium, sodium, and potassium. Lithium is preferable.

Thus, use of the alkali metal salt of an ethylenically unsaturated carboxylic acid as the ethylenically unsaturated carboxylic salt monomer can suppress swelling of the water-soluble polymer of the present invention in an electrolyte. The ethylenically unsaturated carboxylic salt monomers may be used singly or two or more of these may be used.

A part of the carboxylic salt of the ethylenically unsaturated carboxylic salt monomer may be a carboxylic acid (—COOH) as long as the water-soluble polymer is capable of being synthesized by the below-described polymerization method. In cases where a part of the carboxylic salt of the ethylenically unsaturated carboxylic salt monomer is a carboxylic acid, the proportion of the carboxylic acid is preferably 50 mol % or less based on the carboxylic salt included in the ethylenically unsaturated carboxylic salt monomer. The proportion is more preferably 40 mol % or less, and still more preferably 30 mol % or less.

The structural unit (a) is present in the water-soluble polymer of the present invention in a proportion of 50 to 95% by mass based on 100% by mass of the total amount of the structural units included in the water-soluble polymer. The structural unit (a) having a proportion in the range of 50 to 95% by mass leads to easy production of the water-soluble polymer of the present invention by emulsion polymerization. If the proportion of the structural unit (a) exceeds 95% by mass, the solubility in water may become poor and the solution may become inhomogeneous. If the proportion of the structural unit (a) is less than 50% by mass, production by emulsion polymerization may become difficult. The structural unit (a) is preferably present in the water-soluble polymer of the present invention in a proportion of 50 to 80% by mass, and more preferably 50 to 70% by mass.

The structural unit (b) is present in the water-soluble polymer of the present invention in a proportion of 5 to 50% by mass based on 100% by mass of the total amount of the structural units included in the water-soluble polymer. The structural unit (b) having a proportion in the range of 5 to 50% by mass leads to easy production of the water-soluble polymer of the present invention by emulsion polymerization, and can show the solubility of a resulting polymer in water. If the proportion of the structural unit (b) is less than 5% by mass, the solubility in water may become poor and the solution may become inhomogeneous. If the proportion of the structural unit (b) exceeds 50% by mass, the production by emulsion polymerization may become difficult. The structural unit (b) is preferably present in the water-soluble polymer of the present invention in a proportion of 20 to 48% by mass, and more preferably 31 to 45% by mass.

As long as the water-soluble polymer of the present invention includes the structural unit (a) and the structural unit (b) as an essential component, the water-soluble polymer of the present invention may include a structural unit (c) derived from other polymerizable monomers (hereinafter, also simply referred to as “structural unit (c)”). The structural unit (c) shows a structure in which a carbon-carbon double bond of the other polymerizable monomer changes a single bond.

Examples of the other polymerizable monomers include styrene monomers such as styrene, α-methylstyrene, and ethyl vinyl benzene; (meth)acrylamide monomers such as (meth) acrylamide and N,N-dimethyl(meth)acrylamide; polyfunctional allyl monomers such as vinyl acetate and diallyl phthalate; and polyfunctional acrylates such as 1,6-hexanediol diacrylate.

Further, (meth)acrylate or a vinyl compound, containing a polyalkylene oxide group that has a hydrophobic group such as an alkyl group containing 5 to 30 carbon atoms in which a terminal may be halogenated. In this case, because the hydrophobic group is present at an alkylene oxide terminal, association of a hydrophobic group changes viscosity of an electrode composition.

The hydrophobic group at an alkylene oxide terminal is preferably an alkyl group containing 5 to 30 carbon atoms, and more preferably an alkyl group containing 15 to 20 carbon atoms.

Among the other polymerizable monomers, styrene monomers, (meth)acrylamide monomers, polyfunctional allyl monomers, and polyfunctional acrylates are preferable. The other polymerizable monomers may be used singly or two or more of these may be used in combination.

In cases where the water-soluble polymer of the present invention includes the structural unit (c), the structural unit (c) is preferably present in a proportion of 20% by mass or less based on 100% by mass of the total amount of the structural units included in the water-soluble polymer. The proportion is more preferably 10% by mass or less, and still more preferably 5% by mass or less.

That is, the ratio of structural units in the water-soluble polymer of the present invention based on 100% by mass of the total amount of the structural units included in the water-soluble polymer is represented by (structural unit (a) derived from an ethylenically unsaturated carboxylic acid ester monomer)/(structural unit (b) derived from an ethylenically unsaturated carboxylic salt monomer)/(structural unit (c) derived from other polymerizable monomer)=50 to 95% by mass/5 to 50% by mass/0 to 20% by mass.

The structural units (a) and (c) are structural units of components other than the carboxylic acid component of the structural unit (b), which is essential to provide water solubility, and are not essentially particularly limited. The water-soluble polymer of the present invention preferably mainly includes a structural unit derived from an ethylenically unsaturated carboxylic acid ester monomer, which is the structural unit (a), and a structural unit derived from other monomer, which is the structural unit (c), is preferably present in the water-soluble polymer in a proportion of 0 to 20% by mass. Particularly, in cases where the structural unit (a) is derived from the ethylenically unsaturated carboxylic acid ester monomer represented by the formula (I), the ethylenically unsaturated carboxylic acid ester monomer has an ester structure, i.e., a structure —C(═O)—OR′ of the formula (I), and is therefore a hydrophobic monomer, but has a polar group. Therefore, the ethylenically unsaturated carboxylic acid ester monomer is likely to be a core of a drop of an emulsion during emulsion polymerization, and the water-soluble polymer is likely to be homogeneously dissolved in water when neutralized with an alkali metal salt after polymerized. Accordingly, the structural unit (structural unit (a)) derived from an ethylenically unsaturated carboxylic acid ester monomer is essential as a main component other than the structural unit (b), and the proportion thereof needs to be 50 to 95% by mass. As described above, the water-soluble polymer of the present invention contains a hydrophobic portion and a polar portion in a good balance so that such as a positive-electrode active material and a conductive additive are excellently stably dispersed. Further, the water-soluble polymer is suitably as a binder for forming a positive-electrode aqueous composition for a secondary battery including a positive-electrode active material and a conductive additive dispersed therein.

The water-soluble polymer of the present invention may be produced by polymerization of each of the monomer components that provide structural units included in the water-soluble polymer.

The polymerization of the monomer components is not particularly limited and is carried out by, for example, emulsion polymerization, inverse suspension polymerization, suspension polymerization, solution polymerization, aqueous polymerization, and bulk polymerization. Among these polymerization methods, emulsion polymerization is preferable.

In the emulsion polymerization, a high-molecular-weight copolymer is easily polymerizable in high concentration and the viscosity of the polymerization solution is low because the polymerization proceeds in a micell. A water-soluble polymer with a weight-average molecular weight of 500,000 or more is produced by emulsion polymerization as an aqueous dispersion and neutralized with an alkali metal salt to be solubilized (homogenized). Such production can be simply performed and has advantages in production costs.

The emulsion polymerization may be carried out using an emulsifier. Examples of the emulsifier include, but are not particularly limited to, an anionic surfactant, a nonionic surfactant, a cationic surfactant, an amphoteric surfactant, a high molecular surfactant, and a reactive surfactant that is each of these surfactants containing a radical polymerizable unsaturated group.

Particularly, a reactive surfactant has a polymerizable unsaturated group, and is therefore incorporated into a structure of a polymer. Therefore, when an aqueous solution of the surfactant is prepared, the amount of a free surfactant component present in an aqueous solution can be reduced. Accordingly, the reactive surfactant is preferably used. The emulsifiers may be used singly or two or more of these may be used in combination.

Examples of the reactive surfactant include LATEMUL PD (product of Kao Corporation), ADEKA REASORP SR (product of ADEKA Corporation), Aqualon HS (product of DAI-ICHI KOGYO SEIYAKU CO., LTD.), Aqualon KH (product of DAI-ICHI KOGYO SEIYAKU CO., LTD.), and ELEMINOL RS (product of Sanyo Chemical Industries, Ltd.).

As described above, it is one of the preferable embodiments of the present invention that the water-soluble polymer is obtainable by using a reactive surfactant in the emulsion polymerization.

A polymerization initiator may be used for the polymerization of each of the monomer components. The polymerization initiator is not particularly limited and may be a commonly used one as long as it generates a radical molecule by heat. In cases where emulsion polymerization is carried out as polymerization method, a water-soluble initiator is preferably used. Examples of the polymerization initiator include persulfates such as potassium persulfate, ammonium persulfate, and sodium persulfate; water-soluble azo compounds such as a 2,2′-azobis(2-amidinopropane)dihydrochloride and 4,4′-azobis(4-cyanopentanoic acid); thermal cracking initiators such as hydrogen peroxide; and redox initiators such as the combinations of hydrogen peroxide and ascorbic acid, t-butyl hydroperoxide and Rongalit, potassium persulfate and metal salts, and ammonium persulfate and sodium hydrogensulfite. The polymerization initiators may be used singly or two or more of these may be used in combination.

The polymerization initiator is preferably used in an amount of 0.05 to 2 parts by weight, and more preferably 0.1 to 1 part by weight, based on 100 parts by weight of the total amount of the monomer components used in the polymerization reaction.

At the time of the emulsion polymerization, a chain transfer agent may be used in order to control a molecular weight. However, the chain transfer agent needs to be used to adjust a weight-average molecular weight to 500,000 or more. Examples of the chain transfer agent include, but are not particularly limited to, substituted alkane halides, alkyl mercaptans, thioesters, and alcohols. These chain transfer agents may be used singly or two or more of these may be used in combination.

The chain transfer agent is preferably used in an amount of 0 to 1 part by weight based on 100 parts by weight of the total amount of the monomer components used in the polymerization reaction.

The polymerization temperature during the emulsion polymerization may be any temperature, and is preferably 20 to 100° C., and more preferably 50 to 90° C. The polymerization time may also be any time, and is preferably 1 to 10 hours in light of the productivity.

A hydrophilic solvent, an additive, or the like may be added at the time of the emulsion polymerization as long as the resulting copolymer is not adversely affected.

The each monomer component may be added in a reaction system of the emulsion polymerization by any method. Examples of the method include a batch polymerization method, a monomer component dropping method, a pre-emulsion method, a power-feed (emulsion) polymerization, a seed polymerization and a multistage addition method.

The percentage of nonvolatiles of the emulsion after the emulsion-polymerization reaction is preferably 20 to 60%. The fluidity and the dispersion stability of the emulsion having nonvolatiles in a percentage of 20 to 60% are easily maintained. Further, such an emulsion is preferable in terms of production efficiency of a target polymer. On the other hand, an emulsion having nonvolatiles in a percentage of exceeding 60% has too high a viscosity, which may lead to dispersion instability to produce aggregation. An emulsion having nonvolatiles in a percentage of less than 20% has a low concentration of the polymerization system, which may cause a long-time reaction and reduce production efficiency in terms of production quantity of a target polymer.

The average particle size of the emulsion is not particularly limited, and is preferably 10 nm to 1 μm, and still more preferably 30 to 500 nm. An emulsion having a particle size in such a range is less likely to be highly viscous and less likely to aggregate due to the dispersion instability. On the other hand, if an emulsion has a particle size of less than 10 nm, the emulsion may be too viscous or may aggregate due to the dispersion instability. Further, if an emulsion has a particle size exceeding 1 μm, the dispersion stability of the polymer particles is less likely to be maintained.

The average particle size of the emulsion may be determined with particle size measurement equipment by dynamic light scattering.

The water-soluble polymer of the present invention is preferably obtained by neutralization of the polymer particles (aqueous dispersion) obtained by the above method with an alkali metal salt. An alkali metal salt is a salt of lithium, sodium, potassium, or the like. In order to use such a metal salt in neutralization, an aqueous solutions of lithium hydroxide, sodium hydroxide, potassium hydroxide, lithium hydrogen carbonate, sodium hydrogen carbonate, potassium hydrogen carbonate, lithium carbonate, and the like, may be used. Lithium hydroxide, lithium hydrogen carbonate, and lithium carbonate are preferably used. Such neutralization with a metal salt provides a homogeneous aqueous solution with transparent appearance. With respect to the neutralization, 50% or more of the theoretical amount of carboxylic acid is preferably neutralized, and 65% or more thereof is still more preferably neutralized. The pH after the neutralization is 6 or higher, preferably 7 or higher, and preferably not exceeding 9.

It is one of the preferable embodiments of the present invention that the water-soluble polymer is obtainable by neutralizing, with an alkali metal salt, a polymer synthesized by emulsion polymerization.

The solution with transparent appearance means a solution having a total light transmittance of 90 to 100% when the total light transmittance is measured for a 2% by mass aqueous solution of nonvolatiles, which is obtained by neutralization of a polymer resulting from emulsion polymerization with an alkali metal salt. That is, with respect to the water-soluble polymer, a 2% by mass aqueous solution of nonvolatiles has total light transmission of 90 to 100%. The total light transmittance is preferably 95% or higher, and more preferably 97% or higher.

Also, with respect to the water-soluble polymer, a 2% by mass aqueous solution of nonvolatiles preferably has haze of 3% or lower, and more preferably has haze of 1% or lower.

The total light transmittance and haze may be measured using a haze meter “NDH5000” (product name, product of Nippon Denshoku Industries).

The pH value may be measured at 25° C. using a glass electrode type hydrogen ion concentration meter F-21 (product of HORIBA, Ltd.).

The weight-average molecular weight of the water-soluble polymer needs to be 500,000 or more. If the weight-average molecular weight is less than 500,000, desired dispersibility and a viscosity control function can be achieved, but binding properties between particles may be insufficiently improved. Since use of the ethylenically unsaturated carboxylic acid ester monomer improves flexibility, and high molecular weight of 500,000 or more of a weight-average molecular weight increases strength, binding properties are also improved in addition to the dispersibility and a viscosity control function. The weight-average molecular weight is preferably 700,000 to 2,000,000.

The weight-average molecular weight may be measured by a gel permeation chromatography method (GPC method) used in examples described below.

With respect to the water-soluble polymer, a 2% by mass aqueous solution preferably has viscosity of 50 to 20,000 mPa·s, more preferably 100 to 10,000 mPa·s, and still more preferably 150 to 5,000 mPa·s.

The viscosity may be measured using a Brookfield viscometer (product of TOKYO KEIKI INC.) under the condition of 25±1° C. and 30 rpm.

A conductivity enhancing agent of the present invention is explained below. The conductivity enhancing agent of the present invention includes, as an essential component, the aqueous electrode binder for a secondary battery of the present invention including the above water-soluble polymer, a conductive additive, and water. The conductivity enhancing agent of the present invention may respectively include one type of the essential components or may include two or more types thereof.

The conductive additive is used for providing high-power to lithium-ion battery. Conductive carbon is mainly used as the conductive additive. Examples of the conductive carbon include carbon black, fiber carbon, and graphite. Among these, ketjen black, acetylene black, and the like are preferable. The ketjen black has a hollow shell structure and tends to form a conductive network. For this reason, the ketjen black can provide performance equivalent to that provided by conventional carbon black in an amount about half compared to the conventional carbon black. Therefore, the ketjen black is preferably used. Further, acetylene black is carbon black produced using high purity acetylene gas and has few impurities, and has developed surface crystallite. Therefore, such acetylene black is preferable.

The conductive additive preferably has an average particle size of 1 μm or smaller. In cases where the conductive additive having an average particle size of 1 μm or smaller is used, a positive electrode that is formed from a positive-electrode aqueous composition prepared using the conductivity enhancing agent of the present invention can show excellent electrical properties such as output characteristics when used as a positive electrode of a battery. The average particle size is more preferably 0.01 to 0.8 μm, and still more preferably 0.03 to 0.5 μm.

The average particle size of the conductive additive may be measured with a particle size distribution meter by dynamic light scattering (a conductive additive refractive index is set to 2.0).

The conductivity enhancing agent of the present invention preferably further includes a dispersant. Use of a dispersant allows a reduction in viscosity and an increase solids content of the positive-electrode aqueous composition mixed with a positive-electrode active material and the like.

Examples of the dispersant to be used include, but are not particularly limited to, various dispersants such as anionic, nonionic, and cationic surfactants, or polymeric dispersants such as a copolymer of styrene and maleic acid (including a half ester copolymer-ammonium salt). The amount of the dispersant to be used is preferably 5 to 20% by mass based on 100% by mass of the conductive additive. Use of the dispersant in such an amount can provide a conductive additive in the form of sufficiently fine particles and can sufficiently secure the dispersibility when the positive-electrode active material is mixed.

In cases where a positive-electrode aqueous composition including the positive-electrode active material and the like mixed therein is prepared by further using the dispersant in the water-soluble polymer of the present invention to improve the uniform-dispersion stability of the conductive additive, the contact resistance between positive-electrode active material particles can be reduced to achieve good electric conductivity of a positive-electrode film.

Another aspect of the present invention is a positive-electrode aqueous composition for a secondary battery including, as an essential component: the aqueous electrode binder for a secondary battery of the present invention including the water-soluble polymer; a conductive additive; a positive-electrode active material; an emulsion; and water. The composition may include one type of the essential components or may include two or more types thereof.

In the positive-electrode aqueous composition for a secondary battery of the present invention, the above-described water-soluble polymer and conductive additive may be used. The positive-electrode active material used in the electrode aqueous composition for a secondary battery of the present invention is preferably one capable of absorbing and releasing lithium ions. The composition including such a positive-electrode active material may be suitable for a positive electrode of a lithium ion battery. A compound capable of absorbing and releasing lithium ions is, for example, a metal oxide including lithium. Examples of the metal oxide include lithium cobalt oxide, lithium iron phosphate, lithium mangan phosphate, and lithium manganate.

The positive-electrode active material used for the electrode aqueous composition for a secondary battery of the present invention preferably contains a compound having an olivine structure. That is, the positive-electrode active material that includes a compound having an olivine structure is one of the preferable embodiments of the present invention.

The compound having an olivine structure is a compound having a structure represented by the formula:

LixAyDzPO₄

wherein A is one or two or more elements selected from the group consisting of Cr, Mn, Fe, Co, Ni, and Cu; D is one or two or more elements selected from the group consisting of Mg, Ca, Sr, Ba, Ti, Zn, B, Al, Ga, In, Si, Ge, Sc, Y, and rare earth elements; and x, y, and z are numbers satisfying 0<x<2, 0<y<1.5, and 0≦z<1.5, respectively. The compound contains a (PO₄)³⁻ polyanion formed of an oxygen atom and phosphorus bonded to each other in the structure and has oxygen fixed in the crystal structure. Therefore, no combustion reaction theoretically occurs. Accordingly, an electrode active material containing such a compound is excellent in safety and is suitable for a medium or large size power source. Preferable examples of the above-described component A include Fe, Mn, and Ni. Fe is particularly preferable. Preferable examples of the above-described D include Mg, Ca, Ti, and Al.

Examples of the compound having an olivine structure preferably include lithium iron phosphate and lithium mangan phosphate. Lithium iron phosphate is more preferable. Also, the positive-electrode active material to be used is preferably partly or entirely covered with carbon on its surface in order to compensate conductivity. Such covering of its surface with carbon can suppress the deterioration in an aqueous system. The amount of the carbon used for covering the positive-electrode active material is preferably 20 parts by weight or less, and more preferably 10 parts by weight or less, based on 100 parts by weight of the positive-electrode active material.

In the positive-electrode aqueous composition of the present invention, the amount of the compound having an olivine structure is preferably 70 parts by mass or more, and more preferably 90 parts by mass or more, based on 100 parts by mass of the total amount of the positive-electrode active material. Most preferably, the positive-electrode active material is composed of only the compound having an olivine structure.

In the positive-electrode aqueous composition of the present invention, the compound having an olivine structure preferably has an average primary particle size of 1 μm or smaller. Use of a positive-electrode active material that contains a compound having an olivine structure with an average primary particle size of 1 μm or smaller can provide excellent in electrical properties such as output characteristics to a positive-electrode composition for a secondary battery when the composition is used as a battery. The average primary particle size of the compound having an olivine structure is more preferably 0.01 to 0.8 μm. The average primary particle size of the positive-electrode active material may be measured with a particle size distribution meter by dynamic light scattering (in the case of LiFePO₄, 1.7). In cases of using agglomerated particles, the particle size can be observed in a micrograph of an electron microscope such as FE-SEM.

The positive-electrode active material preferably is a positive-electrode active material including lithium iron phosphate as a main component. Among the above compound having an olivine structure, lithium iron phosphate is more preferable and is preferably a main component of the positive-electrode active material. Lithium iron phosphate has high stability to overcharge. Further, lithium iron phosphate is composed of iron and phosphoric acid, which are resources in abundant supply, and is therefore inexpensive and preferable in terms of production costs. Further, lithium iron phosphate is not in a high-voltage system and has reduced impact on a binder. The phrase “including lithium iron phosphate as a main component” means that the amount of lithium iron phosphate based on 100% by weight of the total amount of the positive-electrode active material is 50% or higher. The amount is preferably 80% by weight or higher, and more preferably 90% by weight or higher. Most preferably, the positive-electrode active material is composed of lithium iron phosphate.

In the positive-electrode aqueous composition for a secondary battery of the present invention, an emulsion is preferably used as a binding agent for a positive-electrode active material and a conductive additive. Examples of the emulsion to be used include, but are not particularly limited to, non-fluorine-containing polymers such as (meth)acrylic polymers, nitrile polymers, and diene polymers; and fluorine polymers (fluorine-containing polymers) such as PVDF and PTFE (polytetrafluoroethylene). Unlike the water-soluble polymer, an emulsion to be used is preferably excellent in binding properties between particles and flexibility (membrane flexibility). For this reason, (meth)acrylic polymers, nitrile polymers, and (meth)acrylic modified fluorine polymers are exemplified.

Particularly in a positive electrode, an emulsion of a polymer having a structure of a (meth)acrylic-modified fluorine-containing polymer is preferable because low binding properties, low adhesion, hardness and brittleness of a resulting paint film, which are disadvantages of the fluorine-containing polymer, can be improved by the acrylic modification without impairing chemical and electrical stabilities, which are properties of the fluorine-containing polymer. Vinylidene fluoride polymers such as PVDF and fluorine-containing polymers such as PTFE are a crystalline polymer. When particles are prepared to have an IPN structure in which the (meth)acrylic polymer is incorporated into the fluorine-containing polymer, the crystallinity and the film-forming temperature of the emulsion can be reduced. It is also one of the preferable embodiments of the present invention that the emulsion used for the positive-electrode aqueous composition for a secondary battery of the present invention includes a (meth)acrylic-modified fluorine-containing polymer.

The emulsion preferably includes the (meth)acrylic-modified fluorine-containing polymer in an amount of 60 to 100% by mass, more preferably in an amount of 80 to 100% by mass, and still more preferably in an amount of 90 to 100% by mass, based on 100% by mass of the total amount of the emulsion. Most preferably, the amount is 100% by mass, that is, the emulsion is composed of the (meth)acrylic-modified fluorine-containing polymer.

In the emulsion of the (meth)acrylic-modified fluorine-containing polymer, the ratio of a fluorine-containing polymer portion to an (meth)acrylic polymer portion (fluorine-containing polymer/(meth)acrylic polymer (mass ratio)) is preferably 50/50 to 95/5. The ratio is more preferably 60/40 to 90/10.

The fluorine-containing polymer is preferably a vinylidene fluoride polymer. The vinylidene fluoride polymer is a crystalline polymer. The crystallinity of the polymer can be reduced by (meth)acrylic-modification of the polymer, which results in great effects in terms of improvements in binding properties and flexibility of a resin, and a reduction in a film-forming temperature. Accordingly, use of a (meth)acrylic-modified vinylidene fluoride polymer more sufficiently achieves the effects of chemical and electrical stabilities, which are properties of the fluorine-containing polymer as a binding agent for a secondary battery, and excellent binding properties, flexibility and reducing a film-forming temperature resulting from the (meth)acrylic-modification. The vinylidene fluoride polymer may be produced using only vinylidene fluoride as a raw material, or may be obtained by copolymerization of vinylidene fluoride with an other monomer. The vinylidene fluoride polymer is preferably obtained by copolymerization of vinylidene fluoride with the other monomer. By copolymerizing vinylidene fluoride with the other monomer, the crystallinity of the vinylidene fluoride polymer can be reduced and acrylic modification can be easily carried out.

Examples of the other monomer copolymerized with the vinylidene fluoride (VDF) include, but are not particularly limited to, perfluoro vinyl ethers such as tetrafluoroethylene (TFE), hexafluoropropylene (HFP), and perfluoropropylvinyl ether; and chlorotrifluoroethylene (CTFE), and the like. These monomers may be used singly or two or more of these may be used in combination. Among them, hexafluoropropylene (HFP) and perfluoro alkyl vinyl ethers are preferable.

In cases where the vinylidene fluoride polymer is a copolymer of vinylidene fluoride and the other monomer, the mass ratio of a structure derived from the vinylidene fluoride to a structure derived from the other monomer is preferably 60/40 to 97/3 in terms of reducing the crystallinity of the vinylidene fluoride polymer.

The emulsion of the (meth)acrylic-modified fluorine-containing polymer may be prepared by emulsion polymerization of (meth)acrylic acid and/or (meth)acrylic ester, and if necessary, a monomer component that includes an unsaturated monomer containing a functional group such as carboxylic acid and sulfonic acid, in the presence of aqueous dispersion of particles of the fluorine-containing polymer.

In the positive-electrode aqueous composition for a secondary battery of the present invention, a water-soluble polymer, a positive-electrode active material, a conductive additive, an emulsion, and other components other than these components, in the solids of the positive-electrode aqueous composition are preferably present in ratios (water-soluble polymer/positive-electrode active material/conductive additive/emulsion/other components) of 0.2 to 3.0/70 to 96.8/2 to 20/1 to 10/0 to 5. When an electrode formed from the positive-electrode aqueous composition with such ratios is used as a positive electrode of a battery, excellent output characteristics and electrical properties can be provided. The ratios are more preferably 0.3 to 2.0/80 to 96.7/2 to 10/1 to 6/0 to 2. The “other components” herein refer to components other than the water-soluble polymer, positive-electrode active material, conductive additive, and emulsion, and include a dispersant and the like.

The positive-electrode aqueous composition for a secondary battery of the present invention preferably has viscosity of 1 to 20 Pa·s. In cases where the positive-electrode composition for a secondary battery has viscosity in such a range, appropriate fluidity of the composition can be secured when it's coated. Therefore, such a composition is preferable in terms of workability. The viscosity is more preferably 2 to 12 Pa·s, still more preferably 3 to 10 Pa·s, and most preferably 4 to 7 Pa·s.

Further, the positive-electrode aqueous composition for a secondary battery of the present invention preferably has a thixotropic value of 2.5 to 8. A coating solution with a thixotropic value of less than 2.5 is fluid and likely to be repelled. A coating solution of the composition with a thixotropic value exceeding 8 has no fluidity and has difficulty in applying. The thixotropic value is more preferably 3 to 7.5, and particularly preferably 3.5 to 7. The viscosity of the electrode aqueous composition for a secondary battery may be measured with a Brookfield viscometer (product of TOKYO KEIKI INC.). The thixotropic value may be determined in such a way that the viscosity values at 25±1° C. and 6 rpm and 60 rpm are measured with a Brookfield viscometer (product of TOKYO KEIKI INC.) and the viscosity value at 6 rpm is divided by the viscosity value at 60 rpm.

The positive-electrode aqueous composition for a secondary battery of the present invention preferably has pH of 6 to 10 at 25° C. The pH in such a range less causes corrosion of a collector (for example, aluminum). Therefore, a battery performance of a material is sufficiently exerted. The pH value at 25° C. may be measured using a glass electrode type hydrogen ion thermometer F-21 (product of HORIBA, Ltd.).

The positive-electrode aqueous composition for a secondary battery of the present invention including LiFePO₄ as a positive-electrode active material preferably has an average particle size of 0.05 to 10 μm when the refractive index of a filler component is set to 1.7. The average particle size is measured with a particle size measuring apparatus by dynamic light scattering. When the average particle size of the electrode composition for a secondary battery in a slurry state is in such a range, it can be confirmed that a filler component becomes sufficiently fine particles and is finely mixed. In cases where the average particle size is smaller than 0.05 μm, the solids content needs to be reduced, which causes difficulty in securing the thickness of the coating. In cases where the average particle size exceeds 10 μm, the density of an electrode is less likely to be increased. The average particle size is more preferably 0.1 to 5 μm.

In cases where the positive-electrode aqueous composition for a secondary battery of the present invention includes the water-soluble polymer, positive-electrode active material, conductive additive, emulsion, and water, the preparation method of the positive-electrode aqueous composition is not particularly limited as long as the positive-electrode active material and the conductive additive are uniformly dispersed. The positive-electrode composition for a secondary battery is preferably prepared by preparing an conductivity enhancing agent in such a way that the water-soluble polymer is dissolved in water as a solvent, a dispersant is optionally added thereto, a conductive additive is further blended, the contents are dispersed using a bead, a ball mill, a stirring mixer, or the like; adding a positive-electrode active material to the resulting solution and dispersing it by the same process; and further blending an emulsion. The composition prepared by such a procedure is preferable because the positive-electrode active material and the conductive additive are easily sufficiently uniformly dispersed.

The positive-electrode aqueous composition for a secondary battery of the present invention includes the water-soluble polymer that includes a structural unit (a) derived from an ethylenically unsaturated carboxylic acid ester monomer in an amount of 50 to 95% by mass and a structural unit (b) derived from an ethylenically unsaturated carboxylic salt monomer in an amount of 5 to 50% by mass, and has a weight-average molecular weight of 500,000 or more. The positive-electrode aqueous composition further includes a positive-electrode active material, a conductive additive, and an emulsion. Therefore, the dispersion stability of a filler component such as the positive-electrode active material and the conductive additive is secured, and the composition is excellent in the formation of a coating, adhesion to a substrate, and flexibility. A positive electrode formed from such a positive-electrode aqueous composition can sufficiently exert a performance as a positive electrode for a secondary battery.

A positive electrode for a secondary battery formed by using such a positive-electrode aqueous composition for a secondary battery of the present invention is another aspect of the present invention. Further, a secondary battery formed by using such a positive electrode for a secondary battery is included in the present invention.

Furthermore, a positive electrode for a secondary battery that includes the aqueous electrode binder for a secondary battery of the present invention including the water-soluble polymer, and a positive-electrode active material; and a positive electrode for a secondary battery formed by using the conductivity enhancing agent of the present invention are other aspects of the present invention. And, secondary batteries formed by using such positive electrodes for a secondary battery are also included in the present invention.

The present invention is also a negative-electrode aqueous composition for a secondary battery that includes, as an essential component: the aqueous electrode binder for a secondary battery of the present invention including the water-soluble polymer, a negative-electrode active material; and water. The negative-electrode aqueous composition for a secondary battery of the present invention may include one type of the essential components or may include two or more types thereof. Further, a negative electrode for a secondary battery that includes the aqueous electrode binder for a secondary battery of the present invention including the water-soluble polymer and a negative-electrode active material, and a secondary battery formed by using such a negative electrode for a secondary battery are included in the present invention.

In the negative-electrode aqueous composition for a secondary battery of the present invention, the above water-soluble polymer may be used. Examples of the negative-electrode active material to be used in the electrode aqueous composition for a secondary battery of the present invention include carbon materials such as graphite, natural graphite, and artificial graphite; conductive polymer such as a polyacene; composite metal oxides such as lithium titanate; and a lithium alloy, or the like. Carbon materials are preferably used. It is one of the preferable embodiments of the present invention that the negative-electrode active material includes a carbon negative-electrode material as a main component.

Also, the phrase “negative-electrode active material includes a carbon negative-electrode material as a main component” means that the carbon negative-electrode material is present in a proportion of 50% by mass or higher based on 100% by mass of the total amount of the negative-electrode active material. The carbon negative-electrode material is present in the negative-electrode active material in a proportion of preferably 70 to 100% by mass, and more preferably 80 to 100% by mass. Particularly preferably, the negative-electrode active material is composed of the carbon negative-electrode material.

The negative-electrode aqueous composition for a secondary battery of the present invention may optionally include an emulsion, a conductive additive, a dispersant, a thickener, and the like. Particularly, an emulsion is preferably used because it can provide flexibility as an additional binder component. The emulsion to be used is not particularly limited, and may be the same emulsion as that included in the positive-electrode aqueous composition for a secondary battery of the present invention, or a diene polymer.

A negative-electrode composition including a carbon negative-electrode material as a negative-electrode active material, the aqueous electrode binder for a secondary battery of the present invention including the water-soluble polymer, an emulsion, and water is the most suitable embodiment of the present invention.

In cases where the negative-electrode aqueous composition for a secondary battery of the present invention is used as a material for forming a negative electrode, a water-soluble polymer, a negative-electrode active material, a conductive additive, an emulsion, and other components in the solids of the composition are preferably present in ratios of 0.3 to 2/85 to 99/0 to 10/0.7 to 9/0 to 5. When an electrode formed from a negative-electrode aqueous composition with such ratios is used as a negative electrode of a battery, excellent output characteristics and electrical properties can be provided. The ratios are preferably 0.5 to 1.5/90 to 98.7/0 to 5/0.8 to 3/0 to 3. The “other components” herein refer to components other than the negative-electrode active material, conductive additive, and the binder such as the water-soluble polymer and emulsion, and include a dispersant and thickener.

The viscosity, thixotropic value, and pH of the negative-electrode aqueous composition for a secondary battery of the present invention are preferably the same as the viscosity, thixotropic value, and pH of the positive-electrode aqueous composition for a secondary battery of the present invention.

In cases where the negative-electrode aqueous composition for a secondary battery of the present invention includes the aqueous electrode binder for a secondary battery of the present invention including the water-soluble polymer, negative-electrode active material, emulsion, and water, the preparation method of the negative-electrode aqueous composition is not particularly limited as long as the negative-electrode active material is uniformly dispersed. The negative-electrode composition for a secondary battery is preferably prepared by preparing a uniform aqueous solution of the water-soluble resin dissolved in water as a solvent and an optional dispersant; optionally blending a conductive additive; dispersing using a bead, a ball mill, a stirring mixer, or the like; and blending an emulsion. The composition prepared by such a procedure is preferable because the negative-electrode active material is easily uniformly dispersed.

The negative-electrode aqueous composition for a secondary battery of the present invention includes the water-soluble polymer that includes a structural unit (a) derived from an ethylenically unsaturated carboxylic acid ester monomer in an amount of 50 to 95% by mass and a structural unit (b) derived from an ethylenically unsaturated carboxylic salt monomer in an amount of 5 to 50% by mass, and has a weight-average molecular weight of 500,000 or more. The negative-electrode aqueous composition further includes a negative-electrode active material. Therefore, the dispersion stability of the negative-electrode active material is secured, and a formed coating is excellent in formation function, adhesion to a substrate, and flexibility. A negative electrode formed from such a negative-electrode aqueous composition can sufficiently exert a performance as a negative electrode for a secondary battery.

A negative electrode for a secondary battery obtainable from such a negative-electrode aqueous composition for a secondary battery of the present invention is also another aspect of the present invention. A secondary battery formed by using such a negative electrode for a secondary battery is also another aspect of the present invention.

The secondary battery formed by using the positive electrode for a secondary battery of the present invention including LiFePO₄ as a positive-electrode active material preferably has initial discharge capacity of 120 mAh/g or higher. The initial discharge capacity is more preferably 130 mAh/g or higher.

The secondary battery formed by using the positive electrode for a secondary battery of the present invention preferably has electric capacity retention of 85% or higher after 100 charge/discharge cycles, that is, after 100 times repetition of charge/discharge (also simply referred to as “retention after 100 cycles”). The retention is more preferably 90% or higher. The retention after 100 cycles is determined to confirm that an aqueous electrode binder to be used has satisfying as a binding agent. The electric capacity of the secondary battery may be measured with charge/discharge evaluation equipment.

### Advantageous Effects of Invention

The aqueous electrode binder for a secondary battery of the present invention includes the water-soluble polymer having the above constitution, and has dispersion stability, a viscosity control function, and the effects of preventing a crack occurred when an electrode is formed. The positive-electrode aqueous composition for a secondary battery using such an aqueous electrode binder for a secondary battery allows uniform electrode formation, and does not reduce the flexibility of an electrode. As a result, such a composition can be suitable as a composition forming a positive electrode for a secondary battery. The negative-electrode aqueous composition for a secondary battery using such an aqueous electrode binder for a secondary battery also allows uniform electrode formation, and does not reduce the flexibility of an electrode. As a result, such a composition can be suitable as a composition forming a negative electrode for a secondary battery.

### DESCRIPTION OF EMBODIMENTS

The present invention is described in more detail below with reference to examples, but is not limited only thereto. “Part” means “part by mass” and “%” means “% by weight”, unless otherwise stated.

### Synthesis Example 1

### Synthesis of Water-Soluble Polymer (1)

Into a 4-neck separable flask equipped with a stirrer, a thermometer, a condenser, a nitrogen inlet, and a dropping funnel, ion exchange water (115 parts) and a sulfonic acid ammonium salt of polyoxyethylene dodecyl ether (1.5 parts) were placed. The contents were stirred at an inner temperature of 68° C. while nitrogen was allowed to gently pass through. Thus, the air in the reaction vessel was completely replaced with nitrogen.

Next, sulfonate of polyoxyethylene dodecyl ether (1.5 parts) was dissolved in ion exchange water (92 parts). As monomer components of a polymer, mixture of ethyl acrylate (65 parts) and methacrylic acid (35 parts) were added to prepare a pre-emulsion. A 5% of the pre-emulsion including the monomer components was added to the reaction vessel and was stirred, and then sodium hydrogensulfite (0.017 parts) was added thereto. Separately from this, ammonium persulfate (0.23 parts) was dissolved in ion exchange water (23 parts) to prepare a polymerization initiator aqueous solution. A 5% of the polymerization initiator aqueous solution was added to the reaction vessel and initial polymerization was carried out for 20 minutes. The temperature in the reaction vessel was kept at 72° C., and the remaining pre-emulsion and the initiator aqueous solution were uniformly added dropwise over 2 hours. After the completion of the dropwise addition, a dropping vessel was rinsed with ion exchange water (8 parts) and the water was added to the reaction vessel. The inner temperature of the reaction vessel was kept at 72° C. and the contents were further stirred for 1 hour. Then, the temperature was lowered to complete the reaction. Thus, an emulsion with a solids content of 30% was prepared.

A 5% lithium hydroxide monohydrate aqueous solution (10.2 parts) and ion exchange water (133.2 parts) were added to the resulting emulsion (10 parts/3 parts of solids content) and were stirred. Thus, a water-soluble polymer (1) with a solids content of 2% was prepared. The weight-average molecular weight of the water-soluble polymer (1) was 1,000,000.

The weight-average molecular weight was measured with GPC (gel permeation chromatography) under the following conditions.

Measurement apparatus: GPC (model number: HLC-8120, product of TOSOH CORP.)
Molecular weight column: TSKgel GMHXL (product of TOSOH CORP.)

### Eluent: Tetrahydrofuran (THF)

Standard substance for calibration curve: Polystyrene
Measurement method: A polymer solid before being neutralized was dissolved in an eluent to prepare a solution with a solids content of subject material for measurement in 0.2% by mass. The solution was filtered and subjected to measurement.

### Synthesis Example 2

### Synthesis of Water-Soluble Polymer (2)

An emulsion was prepared as in Synthesis Example 1, except that ethyl acrylate (55 parts), methacrylic acid (40 parts), and methacrylate (5 parts) of an adduct of 30 mol of ethylene oxide with an octadecyl alcohol were used as monomer components of a polymer instead of ethyl acrylate (65 parts) and methacrylic acid (35 parts).

A 5% lithium hydroxide monohydrate aqueous solution (11.7 parts) and ion exchange water (132.3 parts) were added to the resulting emulsion (10 parts/3 parts of solids content) and were stirred. Thus, a water-soluble polymer with a solids content of 2% was prepared. The weight-average molecular weight of the water-soluble polymer (2) was 720,000.

### Synthesis Example 3

### Synthesis of Water-Soluble Polymer (3)

An emulsion was prepared as in Synthesis Example 1, except that sulfonic acid ammonium salt of polyoxyethylene-1-(allyloxymethyl)alkyl ether was used instead of the sulfonic acid ammonium salt of polyoxyethylene dodecyl ether used as a emulsifier. A 5% lithium hydroxide monohydrate aqueous solution (10.2 parts) and ion exchange water (133.2 parts) were added to the resulting emulsion (10 parts/3 parts of solids content) and were stirred. Thus, a water-soluble polymer (3) with a solids content of 2% was prepared. The weight-average molecular weight of the water-soluble polymer (3) was 910,000.

### Experimental Examples 1 to 4

### Evaluation of Electrochemical Stability of Water-Soluble Polymer

To an aqueous solution of each of the water-soluble polymers (1) to (3) and a N-methyl-2-pyrrolidone (NMP) solution of PVDF (HSV-900, Kyner (registered trademark) product of Arkema Inc.), acetylene black were mixed in a weight ratio of acetylene black:binder (solids content)=100:40 to prepare a slurry.

The slurry was applied to an aluminum foil, dried at 100° C., and vacuum dried to prepare a 50-μm-thick film. The film was cut with a 12 mm in diameter and the film was used as a working electrode. An electric current value (μA/cm²) was measured at 25° C. using a Li foil as a counter electrode and a reference electrode. A solution of 1 mol/L LiPF₆ in EC/EMC (1/1) was used as an electrolyte. An electric current value (μA/cm²) was measured at 4.6 V (lithium standard). Other measurement conditions are as follows.

Table 1 shows the evaluation results. Measuring instrument: Cyclic voltammetry HSV-100 (product of Hokuto Denko Corp.)
Initial potential: 3.2 V (lithium standard)
Sweep rate: 5 mV/sec

TABLE 1

| | | Current value |
|---|---|---|
| | | (μA/cm²) |
| Experimental | Water-soluble polymer (1) | 51 |
| Example 1 | | |
| Experimental | Water-soluble polymer (2) | 65 |
| Example 2 | | |
| Experimental | Water-soluble polymer (3) | 50 |
| Example 3 | | |
| Experimental | PVDF | 142 |
| Example 4 | | |

Table 1 shows that the electric current value of each of the water-soluble polymers (1) to (3) used in Experimental Examples 1 to 3, respectively, is smaller than that of PVDF used in Experimental Example 4, and therefore the polymers (1) to (3) are electrically stable even when the relatively high voltage of 4.6 V is applied (lithium standard). For this reason, the polymers (1) to (3) used as a binder for a positive electrode of a secondary battery are found to have good durability and withstand repetitive charge/discharge cycles when compared to PVDF.

### Experimental Examples 5 to 7

### Electrolyte Resistance of Water-Soluble Polymer

A 3-mm-thick frame was formed on a teflon plate (Teflon is a registered trademark). Each of the water-soluble polymers (1) to (3) was poured into the frame and dried at 60° C., 80° C., and 110° C. over time to prepare a 20-mm square specimen. The resulting specimen was immersed in an electrolyte (EC/EMC=1/2) for a day and the height and width of the film were measured. The swelling characteristics were evaluated.

As a result, all the specimens show little changes and the changes are within limits of measurement error (change within 1 mm (within 5%)). Further, the swelling rate is within 15% in terms of volume.

The results show that the water-soluble polymers (1) to (3) hardly swell in an electrolyte.

The EC refers to ethylene carbonate, and the EMC refers to ethyl methyl carbonate.

### (1) Preparation of Positive-Electrode Composition

### Example 1

Water (12.9 parts) and a water-soluble polymer (1) (15.0 parts) were mixed to prepare a homogeneous solution. Acetylene black HS-100 (product of DENKA) (2.40 parts) was added, mixed, and dispersed therein. Next, lithium iron phosphate (made in China) (25.5 parts) was added, mixed, and dispersed therein. Further, an acrylic-modified emulsion of a vinylidene fluoride polymer (VDF/acrylic-modified emulsion (product of Arkema; vinylidene fluoride polymer:acrylic polymer=70:30) (3.75 parts) was added, mixed, and dispersed therein to prepare a positive-electrode composition (1).

### Example 2

Water (9.40 parts), a styrene/maleic acid copolymer dispersant (1.11 parts), and a water-soluble polymer (1) (15.0 parts) were mixed to prepare a homogeneous solution. Acetylene black HS-100 (product of DENKA) (2.40 parts) was added, mixed, and dispersed therein. Next, lithium iron phosphate (made in China) (25.5 parts) was added, mixed, and dispersed therein. A VDF/acrylic-modified emulsion (3.13 parts) was added, mixed, and dispersed therein to prepare a positive-electrode composition (2).

### Example 3

A positive-electrode composition (3) was prepared as in Example 2, except that the water-soluble polymer (2) was used instead of the water-soluble polymer (1).

### Example 4

A positive-electrode composition (4) was prepared as in Example 2, except that the water-soluble polymer (3) was used instead of the water-soluble polymer (1).

### Example 8

Water (21.8 parts), a styrene/maleic acid copolymer dispersant (0.22 parts), and a water-soluble polymer (1) (12.0 parts) were mixed to prepare a homogeneous solution. Acetylene black HS-100 (product of DENKA) (1.80 parts) and lithium iron phosphate (made in China) (27.0 parts) were added, mixed, and dispersed therein. Further, a VDF/acrylic-modified emulsion (1.87 parts) was added, mixed, and dispersed therein to prepare a positive-electrode composition (8).

### Example 9

Water (6.9 parts), a styrene/maleic acid copolymer dispersant (0.55 parts), and a water-soluble polymer (1) (30.0 parts) were mixed to prepare a homogeneous solution. Acetylene black HS-100 (product of DENKA) (1.80 parts) and lithium iron phosphate (made in China) (27.45 parts) were added, mixed, and dispersed therein to prepare a positive-electrode composition (9).

### Example 10

Water (13.8 parts), a styrene/maleic acid copolymer dispersant (0.22 parts), and a water-soluble polymer (1) (12.0 parts) were mixed to prepare a homogeneous solution. Acetylene black HS-100 (product of DENKA) (2.40 parts) and CellSeed C-10 (product of Nippon Chemical Industrial CO., LTD.) (36.4 parts) were added, mixed, and dispersed therein. Further, a VDF/acrylic-modified emulsion (1.87 parts) was added, mixed, and dispersed therein to prepare a positive-electrode composition (10).

### Comparative Example 1

A 1% carboxylmethyl cellulose aqueous solution (CMC1380, product of Daicel Corporation) (30.0 parts) and a styrene/maleic acid copolymer dispersant (1.11 parts) were mixed to prepare a homogeneous solution. Acetylene black HS-100 (product of DENKA) (2.40 parts) was added, mixed, and dispersed therein. Next, lithium iron phosphate (made in China) (25.5 parts) was added, mixed, and dispersed therein. Further, a VDF/acrylic-modified emulsion (3.13 parts) was added, mixed, and dispersed therein to prepare a comparative positive-electrode composition (1).

### Comparative Example 2

A 30% lithium polyacrylate aqueous solution was prepared by 90% neutralization of 35% polyacrylic acid (molecular weight: 100,000) (product of Aldrich) with lithium hydroxide. Then, water (41.0 parts) and a lithium polyacrylate aqueous solution (1.00 part) were mixed to prepare a homogeneous solution. Acetylene black HS-100 (product of DENKA) (2.40 parts) was added, mixed, and dispersed therein. A comparative positive-electrode composition (2) was prepared as in Example 1.

### Comparative Example 5

KYNAR HSV900 (product of Arkema) (1.20 parts) was dissolved in NMP (41.4 parts) to prepare a homogeneous solution. Acetylene black HS-100 (product of DENKA) (1.80 parts) and lithium iron phosphate (made in China) (27.0 parts) were mixed and dispersed therein to prepare a comparative positive-electrode composition (5).

### (2) Various Evaluations of Positive-Electrode Composition

Various evaluations were performed on the positive-electrode compositions (1) to (4) and (8) to (10) obtained in Examples 1 to 4 and 8 to 10, respectively; and the comparative positive-electrode compositions (1), (2), and (5) obtained in Comparative Examples 1, 2, and 5, respectively. The evaluation methods are as described below. Table 2 shows the evaluation results. In Table 2, field of the formulation of each component is represented as “addition amount (part)/solids content (part)”. For example, “15.0/0.30” that is the amount of the water-soluble polymer (1) of Example 1 means that the addition amount of 2% by mass water-soluble polymer solution is 15.0 parts, and the water-soluble polymer (solids content) in the solution is 0.3 parts. The symbol “-” in the column of pH of Comparative Example 5 represents that pH is not measured.

### 1. Viscosity

Viscosity was measured at 25±1° C. and 30 rpm using a Brookfield viscometer (product of TOKYO KEIKI INC.).

### 2. Thixotropic Value

A thixotropic value was determined in such a way that the viscosity values were measured at 25±1° C., at 6 rpm and 60 rpm, using a Brookfield viscometer (product of TOKYO KEIKI INC.), and the viscosity value at 6 rpm was divided by the viscosity value at 60 rpm.

3. pH

pH at 25° C. was measured using a glass electrode type hydrogen ion concentration meter F-21 (product of HORIBA, Ltd.).

### 4. Electrode Formation

A positive-electrode composition was applied using a variable applicator to make a film with a predetermined thickness and dried at 100° C. for 10 minutes. The resulting positive electrode was subjected to a bending test at 10 mm in diameter and evaluated. The evaluation standards are as follows.

Good . . . No problem
Acceptable . . . No crack due to volume shrinkage causes when a film is formed, but a crack occurred when the electrode was bent.
Poor . . . A crack due to volume shrinkage occurred when a film was formed.

### 5. Charge/Discharge Evaluation

A positive-electrode composition was applied using an applicator, dried at 100° C. for 10 minutes and 150° C. for 60 minutes, and pressed at room temperature for 10 minutes. A coin cell (CR2032) was prepared using charge/discharge measuring equipment ACD-001 (product of ASUKA ELECTRONICIS CO., LTD.) and battery evaluation was performed. Other measurement conditions were as follows.

Positive electrode: Positive-electrode composition
Negative electrode: Li foil
Electrolyte: 1 mol/L LiPF₆ in EC/EMC (1/1) (product of KISHIDA CHEMICAL Co., Ltd.)
Charge condition: 0.2 C—CC Cut-off 4.0 V
Discharge condition: 0.2 C—CC Cut-off 2.5 V
Provided that in Example 10 (in the case of CellSeed C-10 (lithium cobalt oxide)), charge condition is 0.2 C—CC Cut-off 4.3 V and discharge condition is 0.2 C—CC Cut-off 2.8 V.

TABLE 2

| | | | Ex- | Ex- | Ex- | Ex- | Ex- | Ex- | Ex- | Com- | Com- | Com- |
|---|---|---|---|---|---|---|---|---|---|---|---|---|
| | | | ample | ample | ample | ample | ample | ample | ample | parative | parative | parative |
| | | | 1 | 2 | 3 | 4 | 8 | 9 | 10 | Example 1 | Example 2 | Example 5 |
| Formulation | Active | Lithium iron | 25.50/ | 25.50/ | 25.50/ | 25.50/ | 27.00/ | 27.45/ | — | 25.50/ | 25.50/ | 27.00/ |
| | material | phosphate | 25.50 | 25.50 | 25.50 | 25.50 | 27.00 | 27.45 | | 25.50 | 25.50 | 27.00 |
| | | CellSeed | — | — | — | — | — | — | 36.40/ | — | — | — |
| | | C-10 | | | | | | | 36.40 | | | |
| | Con- | Acetylene | 2.40/ | 2.40/ | 2.40/ | 2.40/ | 1.80/ | 1.80/ | 2.40/ | 2.40/2.40 | 2.40/2.40 | 1.80/1.80 |
| | duction | black | 2.40 | 2.40 | 2.40 | 2.40 | 1.80 | 1.80 | 2.40 | | | |
| | aid | HS-100 | | | | | | | | | | |
| | Binder | Water-soluble | 15.0/ | 15.0/ | — | — | 12.0/ | 30.0/ | 12.0/ | — | — | — |
| | | polymer (1) | 0.30 | 0.30 | | | 0.24 | 0.60 | 0.24 | | | |
| | | Water-soluble | — | — | 15.0/ | — | — | — | — | — | — | — |
| | | polymer (2) | | | 0.30 | | | | | | | |
| | | Water-soluble | — | — | — | 15.0/ | — | — | — | — | — | — |
| | | polymer (3) | | | | 0.30 | | | | | | |
| | | CMC 1380 | — | — | — | — | — | — | — | 30.0/0.30 | — | — |
| | | Lithium | — | — | — | — | — | — | — | — | 1.00/0.30 | — |
| | | polyacrylate | | | | | | | | | | |
| | | PVDF | — | — | — | — | — | — | — | — | — | 1.20/1.20 |
| | | (HSV900) | | | | | | | | | | |
| | Emulsion | VDF/acrylic- | 3.75/ | 3.13/ | 3.13/ | 3.13/ | 1.87/ | — | 1.87/ | 3.13/1.50 | 3.75/1.80 | — |
| | | modified | 1.80 | 1.50 | 1.50 | 1.50 | 0.90 | | 0.90 | | | |
| | | emulsion | | | | | | | | | | |
| | | (70:30) | | | | | | | | | | |
| | Dis- | Styrene/ | — | 1.11/ | 1.11/ | 1.11/ | 0.22/ | 0.55/ | 0.22/ | 1.11/0.30 | — | — |
| | persant | maleic acid | | 0.30 | 0.30 | 0.30 | 0.05 | 0.15 | 0.06 | | | |
| | | copolymer | | | | | | | | | | |
| | Solvent | Water | 12.9/ | 9.40/ | 9.40/ | 9.40/ | 21.8/ | 6.90/ | 13.8/ | 0.00/0.00 | 41.0/0.00 | — |
| | | | 0.00 | 0.00 | 0.00 | 0.00 | 0.00 | 0.00 | 0.00 | | | |
| | | NMP | — | — | — | — | — | — | — | — | — | 41.4/0.00 |
| Total | | | 59.55/ | 56.54/ | 56.54/ | 56.54/ | 64.69/ | 66.7/ | 66.69/ | 62.14/ | 73.03/ | 71.4/ |
| | | | 30.00 | 30.00 | 30.00 | 30.00 | 30.00 | 30.0 | 40.0 | 30.00 | 30.00 | 30.0 |
| Physical | Theoretical | | 50.4 | 53.0 | 53.0 | 53.0 | 46.5 | 45.0 | 60.0 | 48.3 | 41.1 | 42.0 |
| properties | solids content (%) | | | | | | | | | | | |
| of positive- | Viscosity (mPa · s) | | 5400 | 4000 | 5100 | 4900 | 2000 | 8200 | 2100 | 4500 | 4500 | 5800 |
| electrode | Thixotropic value | | 5.7 | 6.0 | 6.2 | 5.9 | 3.8 | 6.1 | 3.5 | 5.7 | 5.7 | 5.0 |
| composition | pH | | 8.8 | 8.7 | 8.7 | 8.8 | 10.0 | 9.8 | 9.4 | 8.5 | 8.8 | |
| Electrode | Thickness of | | Good | Good | Good | Good | Good | Good | Good | Good | Good | Good |
| formation | dried film 50 μm | | | | | | | | | | | |
| | Thickness of | | Good | Good | Good | Good | Good | Acceptable | Good | Acceptable | Poor | Acceptable |
| | dried film 100 μm | | | | | | | | | | | |
| Electrical | Initial discharge | | 133 | 135 | 133 | 134 | 140 | 131 | 143 | 132 | 132 | 137 |
| properties | capacity (mAh/g) | | | | | | | | | | | |
| (charge/ | Retention after | | 93 | 93 | 90 | 93 | 99 | 94 | 93 | 86 | 90 | 98 |
| discharge | 100 cycles (%) | | | | | | | | | | | |
| condition | | | | | | | | | | | | |
| 0.2 C) | | | | | | | | | | | | |

According to Table 2, a positive-electrode aqueous composition was able to be prepared using the water-soluble polymer of the present invention, and a positive electrode was able to be prepared therefrom. The discharge capacity of such a positive electrode aqueous composition was almost equal to that of the positive-electrode composition (Comparative Example 5) prepared in a solvent system. In comparing the physical properties of the compositions of Examples 1 to 4 with those of the composition of Comparative Example 2, the viscosity values of the compositions are almost equal to each other, but the solids contents are remarkably different from each other. According to Example 8 and Comparative Examples 1 and 2, despite a decrease in the amount of a resin, the results show that binding properties are improved. The water-soluble polymer of the present invention including an ethylene carboxylic acid ester structure is a binder having better adhesion and flexibility than CMC or polyacrylic acid, and prevents the generation of a crack when the polymer is formed into a film.

### (3) Preparation of Negative-Electrode Composition

### Example 5

Water (17.47 g), a water-soluble polymer (1) with a solids content of 2% by weight (15.0 g), and a graphite CGB-10 (product of Nippon Graphite Industries, ltd.) (29.4 g) were added, mixed, and dispersed. A SBR emulsion (product of JSR) (0.63 g) was added to prepare a negative-electrode composition (A). In Table 3, the field of formulation of components is represented as “addition amount (g)/solids content (g)”. For example, “15.0/0.30” that is the amount of the water-soluble polymer (1) of Example 5 means that the addition amount of 2% by mass water-soluble polymer solution is 15.0 g, and the water-soluble polymer (solids content) in the solution is 0.3 g.

### Example 6

A negative-electrode composition (B) was prepared in accordance with the formulation in Table 3 as in Example 5, except that the water-soluble polymer (2) was used instead of the water-soluble polymer (1).

### Example 7

A negative-electrode composition (C) was prepared in accordance with the formulation in Table 3 as in Example 5, except that the water-soluble polymer (3) was used instead of the water-soluble polymer (1).

### Comparative Example 3

A comparative negative-electrode composition (A) was prepared in accordance with the formulation in Table 3 as in Example 5, except that a 1% carboxymethylcellulose aqueous solution (CMC1380, product of Daicel Corporation) (30.0 g) was used instead of water (6.28 g) and the water-soluble polymer (1).

### Comparative Example 4

A 30% lithium polyacrylate aqueous solution was prepared by 90% neutralization of 35% polyacrylic acid (molecular weight: 100,000) (a product of Aldrich) with lithium hydroxide monohydrate aqueous solution. A comparative negative-electrode composition (B) was prepared in accordance with the formulation in Table 3 as in Example 5, except that the amount of water was changed to 38.70 g and the amount of the 30% lithium polyacrylate aqueous solution was changed to 1.00 g.

### (4) Various Evaluations of Negative-Electrode Composition

Evaluations of physical properties of negative-electrode films and electrical properties thereof were performed on the negative-electrode compositions (A) to (C) obtained in Examples 5 to 7, respectively, and the comparative negative-electrode compositions (A) and (B) obtained in comparative examples 3 and 4, respectively. The evaluation method is described below. Table 3 shows the evaluation results.

### 1. Preparation of Negative Electrode Film

A negative-electrode composition was applied to a copper foil using an applicator, dried at 100° C. for 10 minutes, vacuum dried at 100° C., and pressed to prepare a 70-μm negative electrode film.

### 2. Peel Strength

Each of the negative-electrode compositions (A) to (C) and comparative negative-electrode compositions (A) and (B) was applied to a cupper foil to prepare negative electrode films. Each negative electrode film was cut to have a 1-cm width, and a double-stick tape was stuck on the negative-electrode composition side. The cupper foil and the double-stick tape side (with a peeling base) were held, and peel strength was measured in a tensile mode (5 cm/min) using a dynamic viscoelasticity apparatus RSAIII (product of TA Instruments).

### 3. Charge/Discharge Test

A negative-electrode composition was applied using an applicator, dried at 100° C. for 10 minutes and 150° C. for 60 minutes, and pressed at room temperature for 10 minutes. Battery evaluation was performed with charge/discharge measuring equipment ACD-001 (product of ASUKA ELECTRONICIS CO., LTD.) using a coin cell (CR2032). Other measurement conditions were as follows.

Positive electrode: Li foil
Negative electrode: negative-electrode composition
Electrolyte: 1 mol/L LiPF₆ in EC/EMC (1/1) (product of KISHIDA CHEMICAL Co., Ltd.)
Charge condition: 0.2 C—CC Cut-off 0.02 V
Discharge condition: 0.2 C—CC Cut-off 2.0 V

TABLE 3

| | | | | | | Comparative | Comparative |
|---|---|---|---|---|---|---|---|
| | | | Example 5 | Example 6 | Example 7 | Example 3 | Example 4 |
| Formulation | Active material | CGB-10 | 29.40/29.40 | 29.40/29.40 | 29.40/29.40 | 29.40/29.40 | 29.40/29.40 |
| | Binder | Water-soluble polymer (1) | 15.0/0.30 | — | — | — | — |
| | | Water-soluble polymer (2) | — | 15.0/0.30 | — | — | — |
| | | Water-soluble polymer (3) | — | — | 15.0/0.30 | — | — |
| | | CMC 1380 | — | — | — | 30.0/0.30 | — |
| | | Lithium polyacrylate | — | — | — | — | 1.00/0.30 |
| | Emulsion | SBR emulsion | 0.63/0.30 | 0.63/0.30 | 0.63/0.30 | 0.63/0.30 | 0.63/0.30 |
| | Solvent | Water | 17.47/0.00 | 17.47/0.00 | 17.47/0.00 | 6.28/0.00 | 38.70/0.00 |
| Total | | | 62.50/30.00 | 62.50/30.00 | 62.50/30.00 | 66.31/30.00 | 69.70/30.00 |
| Composition | Theoretical solids content (%) | | 48.0 | 48.0 | 48.0 | 45.2 | 43.0 |
| characteristics | | | | | | | |
| Physical properties | Peel strength (gf/cm) | | 13.0 | 12.0 | 12.4 | 8.0 | 7.2 |
| of negative- | | | | | | | |
| electrode film | | | | | | | |

| | | | | | | |
|---|---|---|---|---|---|---|
| Electrical properties | Initial discharge capacity (mAh/g) | | | | | |
| | (charge/discharge condition 0.2 C) | 340 | 336 | 338 | 342 | 340 |

According to Table 3, use of the water-soluble polymer of the present invention as a binder enables dispersion of a negative-electrode active material, and a negative-electrode aqueous composition was prepared therefrom. Further, a negative electrode was prepared from the negative-electrode aqueous composition. In comparing the results of the peel strength in Comparative Examples 3 and 4 with those of the peel strength in Examples 5 to 7, use of the water-soluble polymer of the present invention as a binder was found to provide an electrode excellent in adhesion.

1. An aqueous electrode binder for a secondary battery, comprising a water-soluble polymer,
wherein the water-soluble polymer includes a structural unit (a) derived from an ethylenically unsaturated carboxylic acid ester monomer in an amount of 50 to 95% by mass and a structural unit (b) derived from an ethylenically unsaturated carboxylic salt monomer in an amount of 5 to 50% by mass, based on 100% by mass of the total amount of the structural units included in the water-soluble polymer, and
wherein the water-soluble polymer has a weight-average molecular weight of 500,000 or more.

2. The aqueous electrode binder for a secondary battery according to claim 1,
wherein the ethylenically unsaturated carboxylic acid ester monomer is a compound represented by the formula (1);
CH₂═CR—C(═O)—OR′ (1)
wherein R represents a hydrogen atom or a methyl group and R′ represents an alkyl group containing 1 to 10 carbon atoms, a cycloalkyl group containing 3 to 10 carbon atoms, or a hydroxyalkyl group containing 1 to 10 carbon atoms.

3. The aqueous electrode binder for a secondary battery according to claim 1,
wherein the water-soluble polymer is obtainable by neutralizing, with an alkali metal salt, a polymer synthesized by emulsion polymerization.

4. The aqueous electrode binder for a secondary battery according to claim 3,
wherein the water-soluble polymer is obtainable by using a reactive surfactant in the emulsion polymerization.

5. A conductivity enhancing agent, comprising, as an essential component:
the aqueous electrode binder for a secondary battery according to claim 1;
a conductive additive; and
water.

6. A positive-electrode aqueous composition for a secondary battery, comprising, as an essential component:
the aqueous electrode binder for a secondary battery according to claim 1;
a conductive additive;
a positive-electrode active material;
an emulsion; and
water.

7. The positive-electrode aqueous composition for a secondary battery according to claim 6,
wherein the emulsion includes a (meth)acrylic-modified fluorine-containing polymer.

8. The positive-electrode aqueous composition for a secondary battery according to claim 6,
wherein the positive-electrode active material contains a compound having an olivine structure.

9. A positive electrode for a secondary battery, comprising:
the aqueous electrode binder for a secondary battery according to claim 1; and
a positive-electrode active material.

10. A positive electrode for a secondary battery formed by using the conductivity enhancing agent according to claim 5.

11. A negative-electrode aqueous composition for a secondary battery, comprising, as an essential component:
the aqueous electrode binder for a secondary battery according to claim 1;
a negative-electrode active material; and
water.

12. The negative-electrode aqueous composition for a secondary battery according to claim 11,
wherein the negative-electrode active material includes a carbon negative-electrode material as a main component.

13. A negative electrode for a secondary battery, comprising:
the aqueous electrode binder for a secondary battery according to claim 1; and
a negative-electrode active material.

14. A negative electrode for a secondary battery obtainable from the negative-electrode aqueous composition for a secondary battery according to claim 11.

15. A secondary battery formed by using the positive electrode for a secondary battery according to claim 9.

16. A secondary battery formed by using the negative electrode for a secondary battery according to claim 13.

17. A positive electrode for a secondary battery formed by using the positive-electrode aqueous composition for a secondary battery according to claim 6.

18. The aqueous electrode binder for a secondary battery according to claim 2,
wherein the water-soluble polymer is obtainable by neutralizing, with an alkali metal salt, a polymer synthesized by emulsion polymerization.

19. A conductivity enhancing agent, comprising, as an essential component:
the aqueous electrode binder for a secondary battery according to-claim 2;
a conductive additive; and
water.

20. A conductivity enhancing agent, comprising, as an essential component:
the aqueous electrode binder for a secondary battery according to-claim 3;
a conductive additive; and
water.
